(19) United States
(12) Patent Application Publication
(10) Pub. No.: US 2026/0296580 A1
(43) Pub. Date: Oct. 1, 2026

(54) UTILITY VEHICLE

(71) Applicant: Polaris Industries Inc., Medina, MN (US)

(72) Inventors: Christopher D. Harwood, Roseau, MN (US); Jason R. Fields, Oak Grove, MN (US); Bradley A. Bracht, Salol, MN (US); Andrew C. Schleif, Stacy, MN (US); Michael A. Thomas, Salol, MN (US); John M. LaFata, Blaine, MN (US); Shane A. Novotny, Woodbury, MN (US); Matthew O. Bibeau, Osceola, WI (US); Erin L. Telander, Middle River, MN (US); Christopher J. Hurd, Hugo, MN (US)

(21) Appl. No.: 19/488,909

(22) PCT Filed: May 30, 2024
(86) PCT No.: PCT/US2024/031770

§ 371 Date: Dec. 1, 2025

Related U.S. Application Data
(60) Provisional application No. 63/470,656, filed on Jun. 2, 2023.

(51) Int. Cl. B62D 61/10

(52) U.S. Cl. CPC B62D 61/10

(57) ABSTRACT

A vehicle is provided including a plurality of ground engaging members. A frame is supported by the plurality of ground engaging members. The frame comprises a front frame portion surrounding an operator area and a rear frame portion positioned rearwardly of the front frame portion, and the rear frame portion comprises a first portion and a second portion. A first suspension is coupled between the front frame portion and a first portion of ground engaging members of the plurality of ground engaging members. A second suspension coupled between the first portion of the rear frame portion and a second portion of ground engaging members of the plurality of ground engaging members. A third suspension coupled between the second portion of the rear frame portion and a third portion of ground engaging members of the plurality of ground engaging members. A coupling assembly is coupled between the first portion of the rear frame portion and the second portion of the rear frame portion. The coupling assembly comprises a first coupler member coupled to the first portion of the rear frame portion. A second coupler member is coupled to the second portion of the rear frame portion, the second coupler configured to couple with the first coupler. Further, an eyelet member is coupled to at least one of the first coupler member and the second coupler member.

### CROSS-REFERENCE TO RELATED APPLICATIONS

The present application claims priority to U.S. Provisional Patent Application Ser. No. 63/470,656, filed on Jun. 2, 2023, titled UTILITY VEHICLE, the complete disclosure of which is expressly incorporated by reference herein.

### FIELD OF THE DISCLOSURE

The present disclosure relates to a frame and suspension arrangement of a utility vehicle.

### BACKGROUND OF THE DISCLOSURE

Utility and recreational vehicles may be provided in two-wheel configurations, four-wheel configurations, or six-wheel configurations. Six-wheel vehicles may have a larger wheelbase, may carry greater loads, and be subjected to greater forces. Additionally, six-wheel vehicles may require specific control strategies and methods of operation.

### SUMMARY OF THE DISCLOSURE

In an embodiment of the present disclosure, a vehicle is provided. The vehicle comprising a plurality of ground engaging members. A frame is supported by the plurality of ground engaging members. The frame comprises a front frame portion surrounding an operator area and a rear frame portion positioned rearwardly of the front frame portion, and the rear frame portion comprises a first portion and a second portion. A first suspension is coupled between the front frame portion and a first portion of ground engaging members of the plurality of ground engaging members. A second suspension coupled between the first portion of the rear frame portion and a second portion of ground engaging members of the plurality of ground engaging members. A third suspension coupled between the second portion of the rear frame portion and a third portion of ground engaging members of the plurality of ground engaging members. A coupling assembly is coupled between the first portion of the rear frame portion and the second portion of the rear frame portion. The coupling assembly comprises a first coupler member coupled to the first portion of the rear frame portion. A second coupler member is coupled to the second portion of the rear frame portion, the second coupler configured to couple with the first coupler. Further, an eyelet member is coupled to at least one of the first coupler member and the second coupler member.

In another embodiment of the present disclosure, a vehicle is provided. The vehicle comprises a plurality of ground engaging members and a frame supported by the plurality of ground engaging members. The frame comprises a front frame portion surrounding an operator area and a rear frame portion. A first suspension is coupled between the front frame portion and a first portion of ground engaging members of the plurality of ground engaging members. A second suspension is coupled between the first portion of the rear frame portion and a second portion of ground engaging members of the plurality of ground engaging members. A third suspension is coupled between the second portion of the rear frame portion and a third portion of ground engaging members of the plurality of ground engaging members. Further, a first eyelet is coupled to the front frame portion, and the first eyelet positioned forward of the operator area. A second eyelet is coupled to the rear frame portion and the second eyelet is positioned longitudinally intermediate the second suspension and the third suspension.

In yet another embodiment of the present disclosure, a vehicle is provided. The vehicle comprising a plurality of ground engaging members and a frame supported by the plurality of ground engaging members. The frame comprises a front frame portion surrounding an operator area and a rear frame portion positioned rearwardly of the operator area. The rear frame portion comprises a lower frame portion and an upper frame portion vertically spaced from the lower frame portion. A first suspension is coupled between the front frame portion and a first portion of ground engaging members of the plurality of ground engaging members. A second suspension is coupled between the rear frame portion and a second portion of ground engaging members of the plurality of ground engaging members. The second suspension is coupled between the lower frame portion of the rear frame portion and the upper frame portion of the rear frame portion. A third suspension is coupled between the rear frame portion and a third portion of ground engaging members of the plurality of ground engaging members, and the third suspension is longitudinally spaced from the second suspension and coupled between the lower frame portion of the rear frame portion and the upper frame portion of the rear frame portion. Further, a storage member is supported by the rear frame portion, and the storage member is positioned at a height vertically intermediate the lower frame portion and the upper frame portion and longitudinally intermediate the seconds suspension and the third suspension.

In yet another embodiment of the present disclosure, a vehicle is provided. The vehicle comprises a plurality of ground engaging members including a first pair of ground engaging members and a second pair of ground engaging members positioned rearwardly of the first pair of ground engaging members and a third pair of ground engaging members positioned longitudinally intermediate of the first pair of ground engaging members and the second pair of ground engaging members. A frame is supported by the plurality of ground engaging members, and the frame extends along a longitudinal centerline. A first suspension is coupled between the frame and the first pair of ground engaging members. A second suspension is coupled between the frame and the second pair of ground engaging members. A third suspension is coupled between the frame and the third pair of ground engaging members. A controller is operably coupled to at least tow of the first suspension, second suspension, and the third suspension, and the controller is configured to alter a height of the first suspension and at least one of the second suspension and the third suspension.

In yet another embodiment of the present disclosure, a method of controlling a vehicle suspension is provided. The vehicle suspension includes a first suspension including a first shock absorber and a second shock absorber. A second suspension includes a third shock absorber and a fourth shock absorber positioned rearwardly of the first suspension. A third suspension includes a fifth shock absorber and a sixth shock absorber positioned rearwardly of the second suspension. The method includes altering, in response to a user input, a height of the first shock absorber and the second shock absorber. Further, altering, in response to the user input, a height of a first portion of the third shock absorber, fourth shock absorber, fifth shock absorber, and sixth shock absorber and a second portion of the third shock absorber, fourth shock absorber, fifth shock absorber, and sixth shock absorber.

In yet another embodiment of the present disclosure, a vehicle is provided. The vehicle includes a plurality of ground engaging members. A frame is supported by the plurality of ground engaging members and a powertrain is supported by the frame. The powertrain includes a prime mover, a first drive member operably coupled between the prime mover and a first pair of ground engaging member so the plurality of ground engaging members. The first drive member is operable in a first state and a second state. A second drive member is operably coupled between the prime mover and a second pair of ground engaging members of the plurality of ground engaging members, and the second drive member is operable in a first state and a second state. A third drive member is operably coupled between the prime mover and a third pair of ground engaging members of the plurality of ground engaging members, and the third drive member is operable in a first state and a second state. Further, a controller is operably coupled to each of the first drive member, second drive member, and the third drive member.

The controller is operable to alter the first drive member between the first state and the second state, and the second drive member is between the first state and the second state, and the third drive member is between the first state and the second state.

### BRIEF DESCRIPTION OF THE DRAWINGS

FIG. 1 is a front perspective view of a vehicle of the present disclosure;

FIG. 2 is a rear perspective view of the vehicle of FIG. 1;

FIG. 3A is a left side view of the vehicle of FIG. 1 with the wheels at a first height;

FIG. 3B is a left side view of the vehicle of FIG. 1 with the wheels at a second height;

FIG. 4 is a right side view of the vehicle of FIG. 1;

FIG. 5 is a top view of the vehicle of FIG. 1;

FIG. 6 is a front view of the vehicle of FIG. 1;

FIG. 7 is a rear view of the vehicle of FIG. 1;

FIG. 8 is a front perspective view of a frame and powertrain of the vehicle of FIG. 1;

FIG. 9A is a perspective view of a powertrain of the present disclosure;

FIG. 9B is a flow chart of a process for the operation of the powertrain of FIG. 9A;

FIG. 10 is a front perspective view of the frame of FIG. 8 with a plurality of suspensions;

FIG. 11 is a rear perspective view of the frame of FIG. 8 with a plurality of suspensions;

FIG. 12 is a side view of a portion of the frame of FIG. 8;

FIG. 13 is a control diagram for control of a vehicle of the present disclosure;

FIG. 14A is a diagrammatic view of a vehicle with height adjustment capabilities;

FIG. 14B is a diagrammatic view of a vehicle with height adjustment capabilities;

FIG. 14C is a diagrammatic view of a vehicle with height adjustment capabilities;

FIG. 14D is a diagrammatic view of a vehicle with height adjustment capabilities;

FIG. 14E is a diagrammatic view of a vehicle with height adjustment capabilities;

FIG. 14F is a diagrammatic view of a vehicle with height adjustment capabilities;

FIG. 14G is a diagrammatic view of a vehicle with height adjustment capabilities;

FIG. 15 is a perspective view of a coupling assembly for a frame of the present disclosure;

FIG. 16 is a partially exploded view of the coupling assembly of FIG. 15;

FIG. 17 is a perspective view of a first portion of the coupling assembly of FIG. 15;

FIG. 18 is a perspective view of the first portion of the coupling assembly of FIG. 17;

FIG. 19 is a perspective view of a second portion of the coupling assembly of FIG. 15; and

FIG. 20 is a perspective view of the second portion of the coupling assembly of FIG. 19.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative components and other components and features. Such use is not intended to denote an ordering of the components. Rather, numeric terminology is used to assist the reader in identifying the component being referenced and should not be narrowly interpreted as providing a specific order of components.

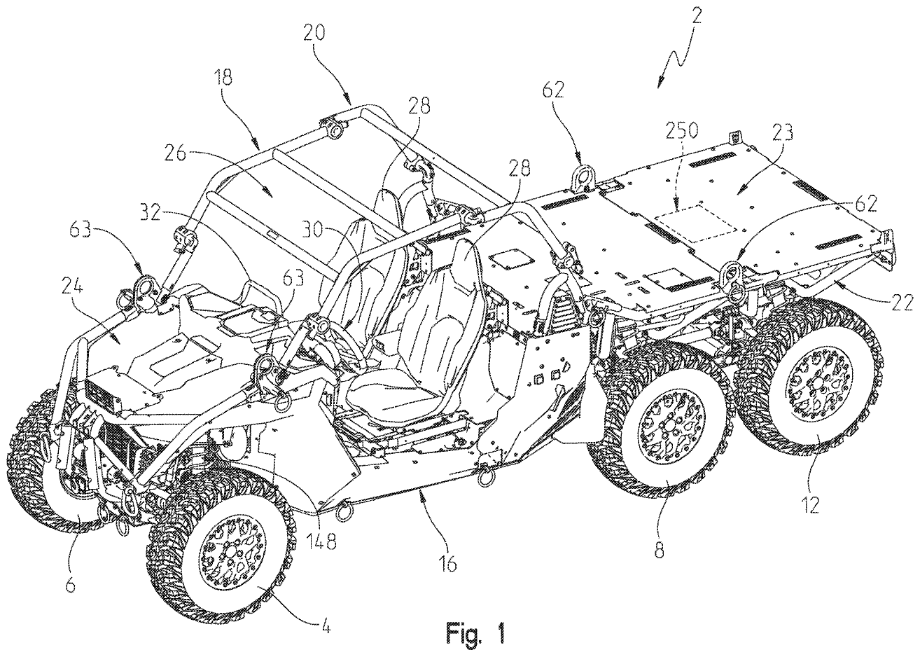

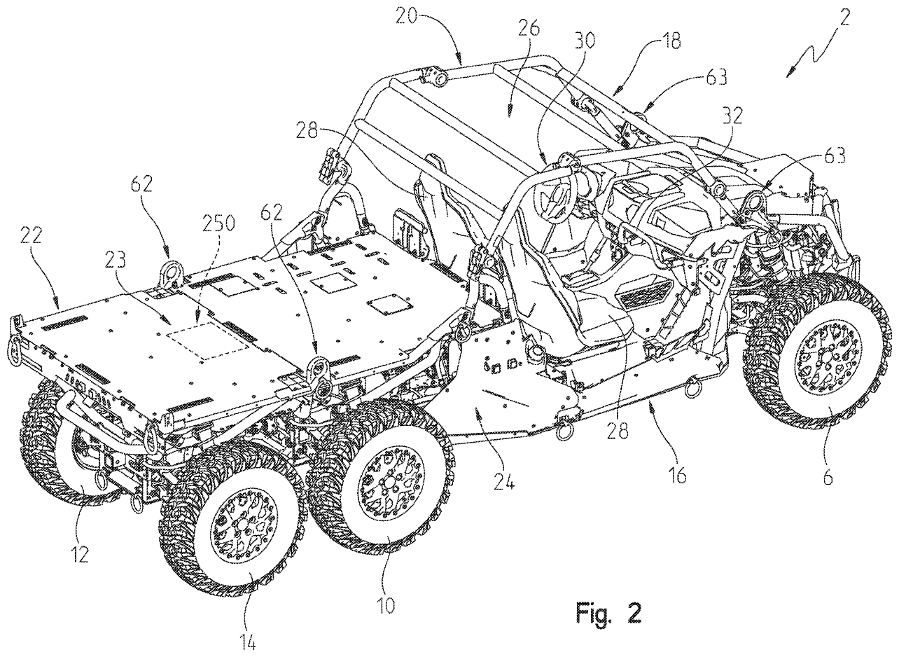

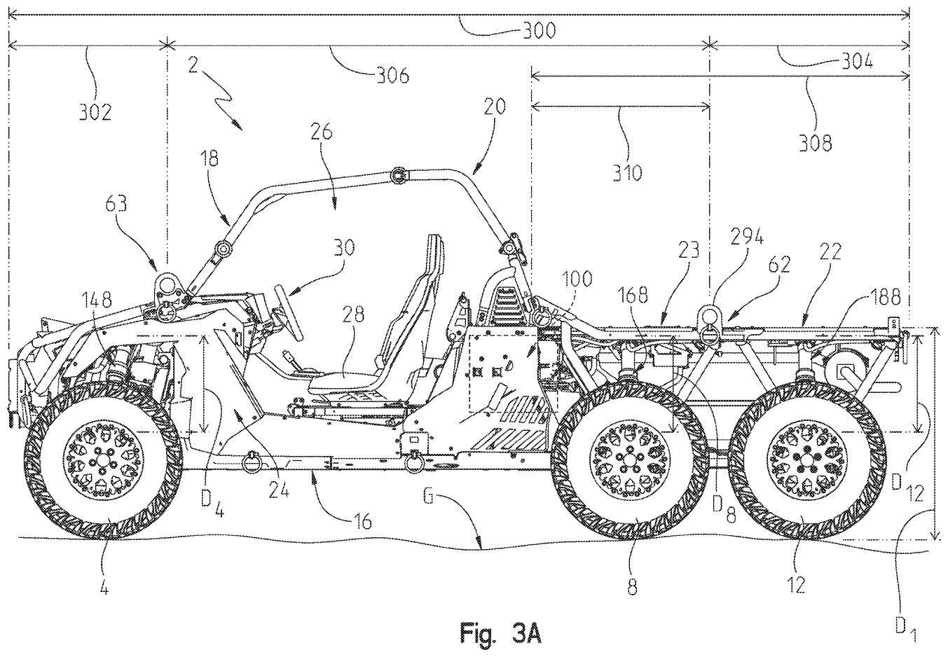

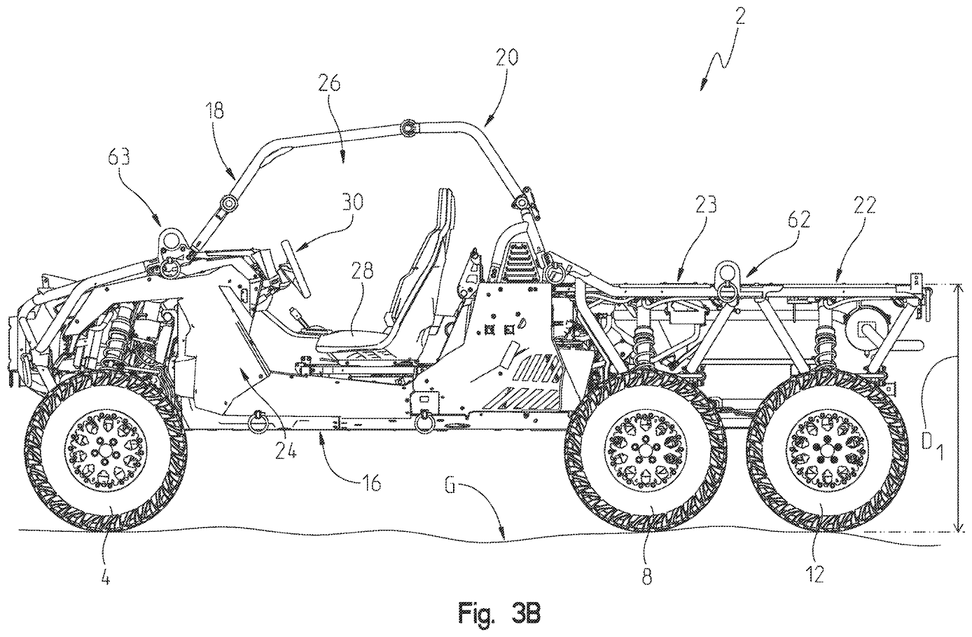

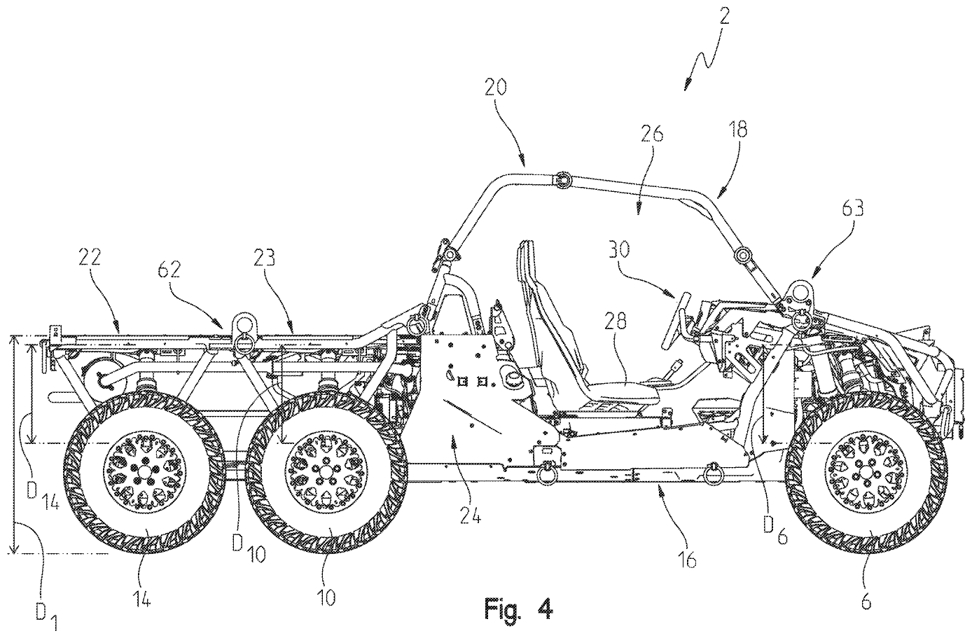

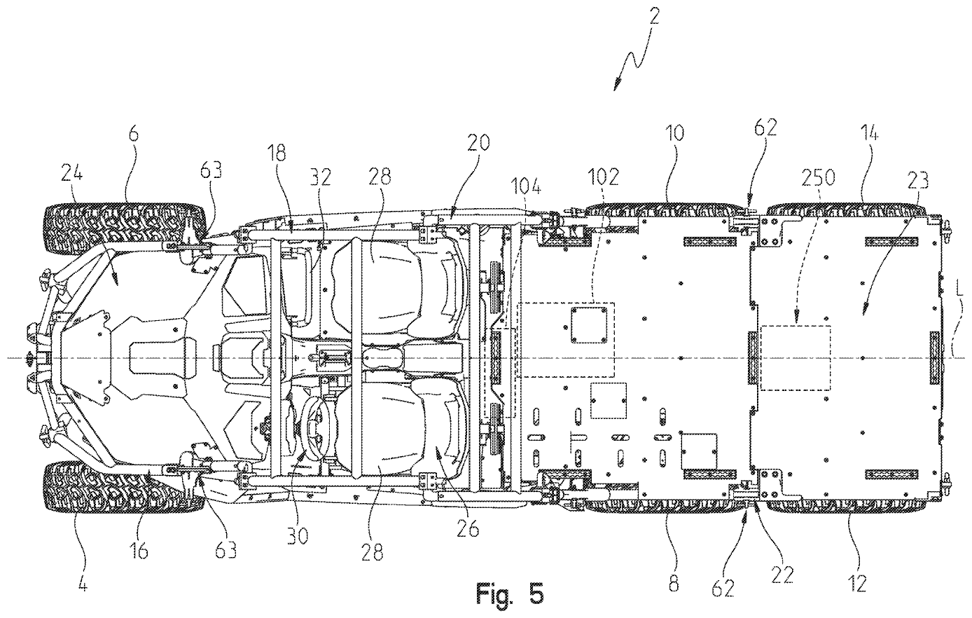

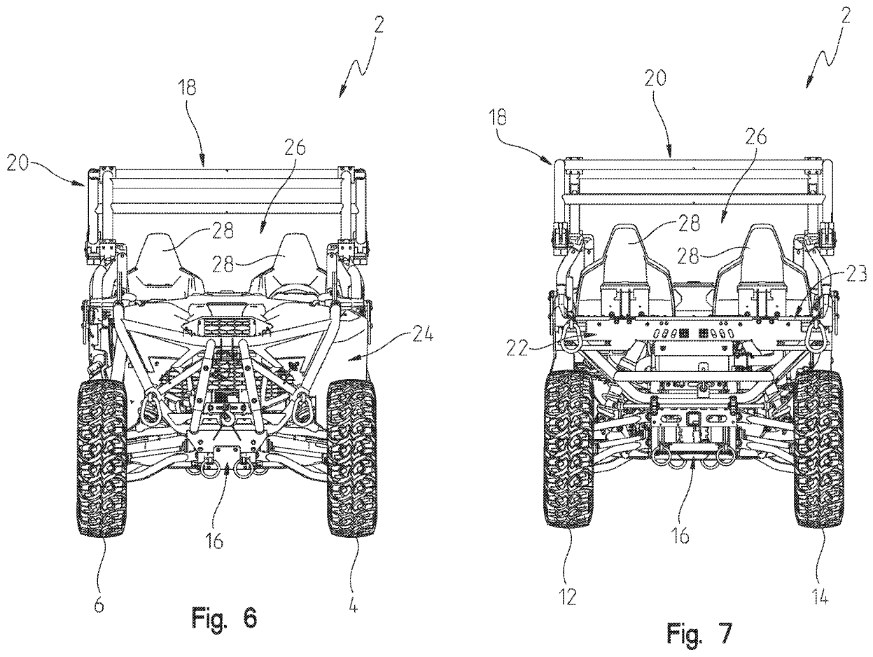

Referring now to FIGS. 1-7, a vehicle 2 includes a plurality of ground engaging members including a front left ground engaging member 4, a front right ground engaging member 6, a middle left ground engaging member 8, a middle right ground engaging member 10, a rear left ground engaging member 12, and a rear right ground engaging member 14. A frame assembly 16 is supported by the plurality of ground engaging members, and frame 16 includes a front frame portion 18 and a rear frame portion 22. Front frame portion 18 includes a lower frame assembly 19 and an upper frame assembly 20 surrounding an operator area 26. A pair of seats 28 are positioned within operator area 26 and configured to support one or more passengers. In embodiments, operator area 26 includes one seat, two seats, three seats, four seats, five seats, six seats or more seats. A steering input 30 is positioned within operator area 26, and illustratively, steering input 30 is a steering wheel. In embodiments, steering input 30 is a handlebar assembly or another type of steering input. A grab bar 32 is positioned within operator area 26 and capable of being grasped by a passenger of vehicle 2. A pair of tie-downs, or hooking members, 63 are coupled to frame assembly 16 and positioned longitudinally forward of operator area 26. A body assembly 24 is supported by frame 16 and includes one or more body panels which may include a hood, fender, door, grille, or another body member. Rear frame portion 22 supports a cargo bed, or storage area, 23 with a bed length 308 (FIG. 3A).

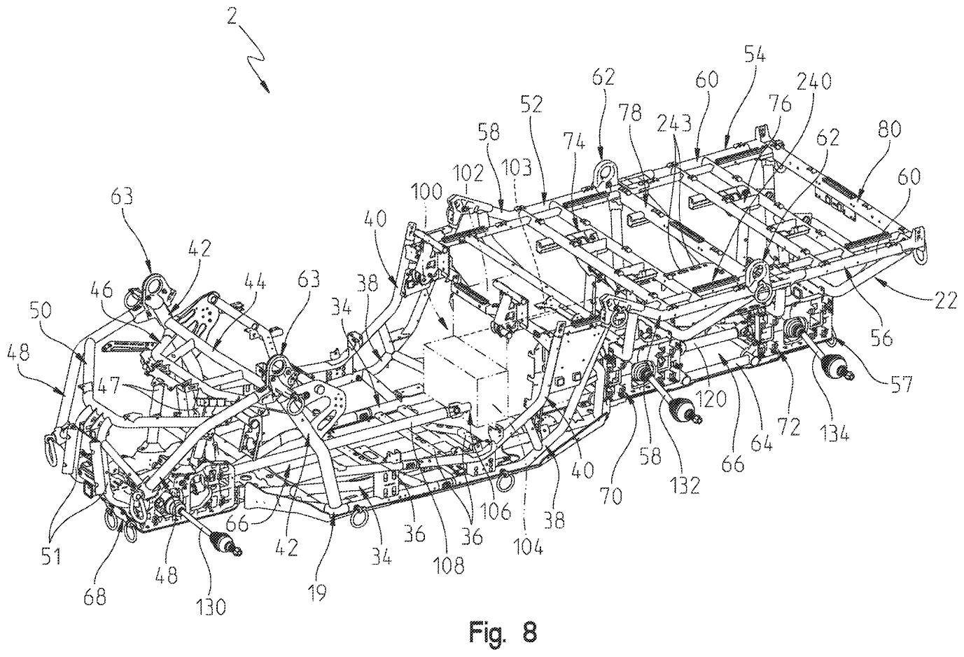

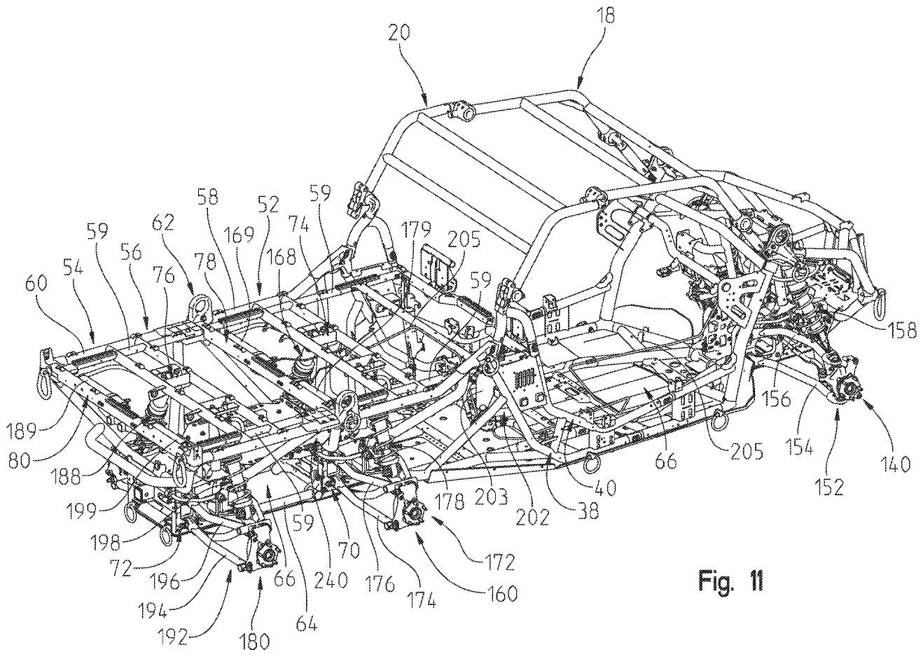

Now referring to FIGS. 8-11, lower frame assembly 19 includes a pair of main longitudinally extending frame members 34 and a plurality of lateral frame members 36 extending between the main longitudinally extending frame members 34. A pair of lower outer longitudinally extending members 38 are positioned on either side of, and outwardly, relative to the main longitudinally extending frame members 34, and a pair of upper outer longitudinally extending members 40 are positioned vertically above the lower outer longitudinally extending members 38. A pair of vertical frame members 42 extend upwardly from members 38, and a cross-member 44 extends between each of the vertical frame members 42. A U-shaped frame member 46 extends forward of at least a portion of cross-member 44. A pair of generally longitudinally extending frame members 48 extend forwardly and downwardly from vertical frame members 42, and a U-shaped frame member 50 extends between longitudinally extending frame members 48. A first housing or casting 68 is positioned at a front of lower frame assembly 19 and is coupled to each of frame members 34, members 38, and frame members 48. A pair of vertically extending members 47 are coupled between U-shaped frame member 46 and first casting 68 and a pair of vertically extending members 51 are coupled between U-shaped frame member 50 and first casting 68.

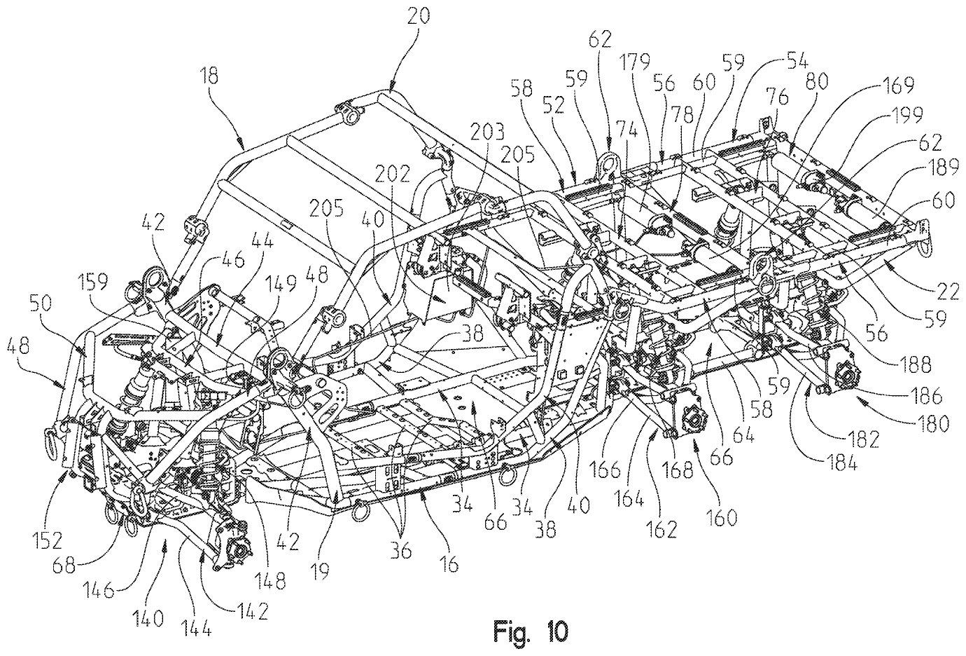

Rear frame portion 22 includes an upper frame portion 56 and a lower frame portion 57. Rear frame portion 22 may also be separated into a first frame portion 52 and a second frame portion 54 positioned rearwardly of first frame portion 52. Upper frame portion 56 includes a pair of first frame members 58 positioned at either lateral extent of rear frame portion 22 and a pair of second frame members 60 positioned at either lateral extent of rear frame portion 22 and rearwardly of first frame members 58. A pair of coupling assemblies 62 are coupled intermediate first frame members 58 and second frame members 60. As shown in at least FIG. 10, a pair of frame members 59 extend longitudinally and generally parallel to upper frame members 58, 60. Frame members 59 are positioned laterally inwardly from frame members 58, 60. In embodiments, frame members 59 extend forwardly from frame members 40 and are coupled to coupling assemblies 62. In embodiments, frame members 59 are unitary members. In embodiments, frame members 59 are comprised of a plurality of frame members.

Lower frame portion 57 includes a second housing or casting 70, a third housing or casting 72, and a pair of frame members 64 coupled between each of second casting 70 and third casting 72. In embodiments, a skid plate 66 is positioned on a lower side of lower frame assembly 19 and lower frame portion 57. Skid plate 66 may be a single piece or comprised of multiple pieces and configured to cover, from below, one or more of castings 68, 70, 72, frame members 34, 36, 38, 34 or other components supported by frame 16. Rear frame portion 22 also includes a plurality of cross members extending between upper frame portions 56. A first cross member 74 (FIG. 8) extends between upper frame portions 56, a second cross member 76 (FIG. 8) extends between upper frame portions 56 at a position generally rearwardly of the first cross member 74, a third cross member 78 (FIG. 8) extends between upper frame portions 56 at a position longitudinally intermediate cross members 74, 76, and a fourth cross member 80 (FIG. 8) extends between upper frame portions 56 at a position longitudinally rearwardly of second cross member 76 (FIG. 8).

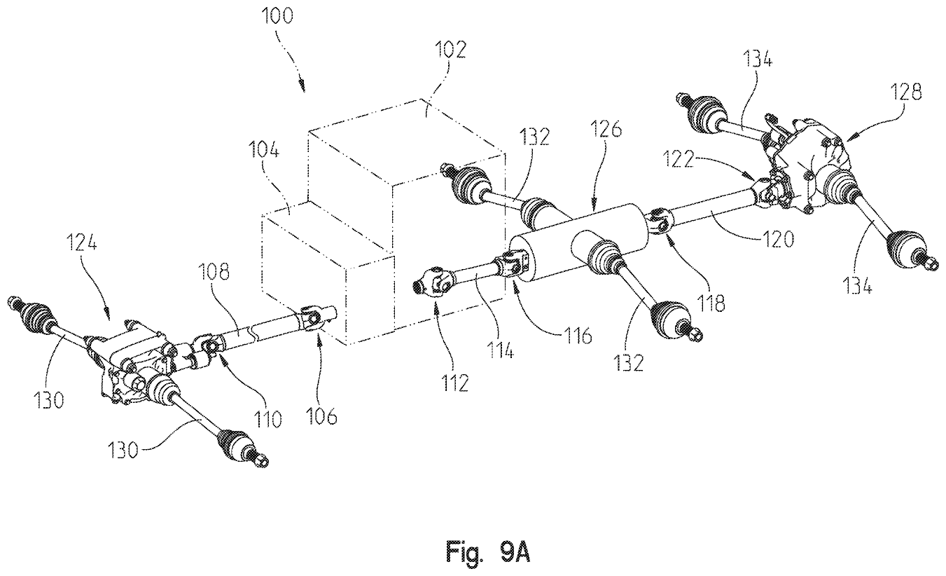

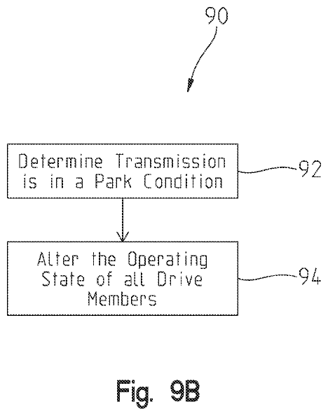

Referring to FIGS. 8-9, vehicle 2 includes a powertrain assembly 100. Powertrain assembly 100 includes a prime mover 102 operably coupled to a transmission 104. In embodiments prime mover 102 is an engine comprising a cylinder head (not shown), crankcase (not shown), and a crankshaft positioned within the crankcase extending along an engine centerline 103. In the present embodiment, prime mover 102 is an engine extending generally longitudinally. That is, engine centerline 103 extends generally longitudinally. In embodiments, engine centerline 103 is generally parallel or colinear with a vehicle centerline L. However, in other embodiments, engine centerline 103 may be angled relative to vehicle centerline L. In the present embodiment, prime mover 102 is positioned substantially forwardly of middle suspension 160, middle left ground engaging member 8, and middle right ground engaging member 10. In embodiments, prime mover 102 is positioned entirely forward of middle left ground engaging member 8 and middle right ground engaging member 10. It may be appreciated that prime mover 102 may be in any position relative to middle ground engaging members 8, 10. In embodiments, prime mover 102 is an electric motor or another type of propulsion unit. Transmission 104 may be a shiftable transmission or a continuously variable transmission (CVT) (e.g., a rubber belt CVT, a steel belt CVT, an electronic CVT, or another CVT). In embodiments, transmission 104 may be a combination of a shiftable transmission and a continuously variable transmission.

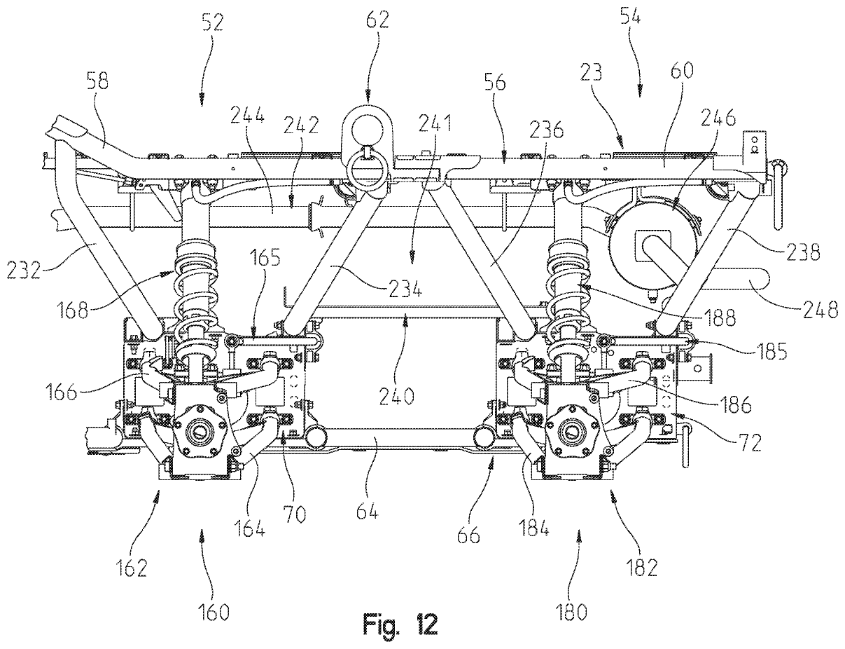

Still referring to FIGS. 8-9, transmission 104 includes a first output 106 extending generally forwardly from transmission 104 and a second output 112 extending generally rearwardly from transmission 104. A first drive shaft 108 is coupled to first output 106 and extends forwardly from transmission 104 and couples to a first drive member 124 at a first drive member input 110. In embodiments, each of first output 106 and first drive member input 110 are CV joints, or universal joints. First drive member 124 is coupled intermediate front left ground engaging member 4 and front right ground engaging member 6, and a first halfshaft 130 extends between first drive member 124 and front left ground engaging member 4 and a second halfshaft 130 extends between first drive member 124 and front right ground engaging member 6. A second drive shaft 114 is coupled to second output 112 and extends rearwardly from transmission 104 and couples to a second drive member 126 at a second drive member input 116. In embodiments, each of second output 112 and second drive member input 116 are CV joints, or universal joints. Second drive member 126 is coupled intermediate middle left ground engaging member 8 and middle right ground engaging member 10, and a third halfshaft 132 extends between second drive member 126 and middle left ground engaging member 8 and a fourth halfshaft 132 extends between second drive member 126 and middle right ground engaging member 10. Second drive member 126 also includes a second drive member output 118 extending rearwardly from second drive member 126. A third drive shaft 120 extends rearwardly from second drive member 126 and couples to a third drive member 128 at a third drive member input 122. Third drive member 128 is coupled intermediate rear left ground engaging member 12 and rear right ground engaging member 14, and a fifth halfshaft 134 extends between third drive member 128 and rear left ground engaging member 12 and a sixth halfshaft 134 extends between third drive member 128 and rear right ground engaging member 14. In embodiments, powertrain 100 includes an exhaust assembly 242 (FIG. 12) fluidly coupled to prime mover 102. Exhaust assembly 242 includes an exhaust conduit 244 (FIG. 12) coupled between prime mover 102 and a silencer 246 (FIG. 12). Silencer 246 is fluidly coupled to a tail pipe 248 (FIG. 12).

Still referring to FIGS. 8-9, powertrain 100 is configured to provide power to one or more of front left ground engaging member 4, front right ground engaging member 6, middle left ground engaging member 8, middle right ground engaging member 10, rear left ground engaging member 12, and rear right ground engaging member 14. In embodiments, each of first drive 124, second drive 126, and third drive 128 are differentials. In embodiments, drives 124, 126, 128 are locking differentials, electronic differentials, or an open differential. Prime mover 102 is configured to provide power to transmission 104, which is configured to transfer power to one or both of first output 106 and second output 112. In embodiments, prime mover 102 and transmission 104 are configured to provide power to one or more of first drive 124, second drive 126, and third drive 128. In embodiments, vehicle is configured to operate with one or more of first drive 124, second drive 126, and third drive 128 in an open condition, or unlocked condition and a locked condition.

Still referring to FIGS. 8-9A, vehicle 2 may be configured to operate in a 1×6 drive mode (i.e., power provided to 1 of the 6 ground engaging members) and each of first drive 124, second drive 126, and third drive 128 are in an open condition and power is only provided to one of first drive 124, second drive 126, and third drive 128 (e.g., power only provided to third drive 128 in an open condition). That is, in embodiments, vehicle 2 may be configured to operate in a 2×6 drive mode (i.e., power provided to 2 of the 6 ground engaging members) and each of first drive 124, second drive 126, and third drive 128 are in an open condition and power is provided to two of the first drive 124, second drive 126, and third drive 128 (e.g., power provided to second drive 126 and third drive 128 in an open condition). In embodiments, vehicle 2 may be configured to operate in a 2×6 drive mode (i.e., power provided to 2 of the 6 ground engaging members) and one of first drive 124, second drive 126, and third drive 128 are in a locked condition and power is provided to the one drive of the first drive 124, second drive 126, and third drive 128 in a locked condition (e.g., power provided to third drive 128 in a locked condition). In embodiments, vehicle 2 may be configured to operate in a 3×6 drive mode (i.e., power provided to 3 of the 6 ground engaging members) and one of first drive 124, second drive 126, and third drive 128 are in a locked condition and power is provided to the one drive of the first drive 124, second drive 126, and third drive 128 in a locked condition and a second drive of the first drive 124, second drive 126, and third drive 128 in an unlocked condition (e.g., power provided to third drive 128 in a locked condition and second drive 126 in an unlocked condition). In embodiments, vehicle 2 may be configured to operate in a 3×6 drive mode (i.e., power provided to 3 of the 6 ground engaging members) and each of first drive 124, second drive 126, and third drive 128 are in an open condition and power is provided to each of the first drive 124, second drive 126, and third drive 128 in the unlocked condition. In embodiments, vehicle 2 may be configured to operate in a 4×6 drive mode (i.e., power provided to 4 of the 6 ground engaging members) and two of the first drive 124, second drive 126, and third drive 128 are in a locked condition and power is provided to the two drives of the first drive 124, second drive 126, and third drive 128 in the locked condition (e.g., power provided second drive 126 and third drive 128 in a locked condition). In embodiments, vehicle 2 may be configured to operate in a 4×6 drive mode (i.e., power provided to 4 of the 6 ground engaging members) and two drives of the first drive 124, second drive 126, and third drive 128 are in an unlocked condition and the third drive of the first drive 124, second drive 126, and third drive 128 is in a locked condition and power is provided to the two drives of the first drive 124, second drive 126, and third drive 128 in the unlocked condition and the third drive of the first drive 124, second drive 126, and third drive 128 in the locked condition (e.g., power provided second drive 126 and third drive 128 in an unlocked condition and first drive 124 in a locked condition). In embodiments, vehicle 2 may be configured to operate in a 5×6 drive mode (i.e., power provided to 5 of the 6 ground engaging members) and two drives of the first drive 124, second drive 126, and third drive 128 are in a locked condition and the third drive of the first drive 124, second drive 126, and third drive 128 is in an unlocked condition and power is provided to the two drives of the first drive 124, second drive 126, and third drive 128 in the locked condition and the third drive of the first drive 124, second drive 126, and third drive 128 in the unlocked condition (e.g., power provided second drive 126 and third drive 128 in a locked condition and first drive 124 in an unlocked condition). In embodiments, vehicle 2 may be configured to operate in a 6×6 drive mode (i.e., power provided to 6 of the 6 ground engaging members) and each of first drive 124, second drive 126, and third drive 128 are in a locked condition and power is provided to each of the first drive 124, second drive 126, and third drive 128 in the locked condition.

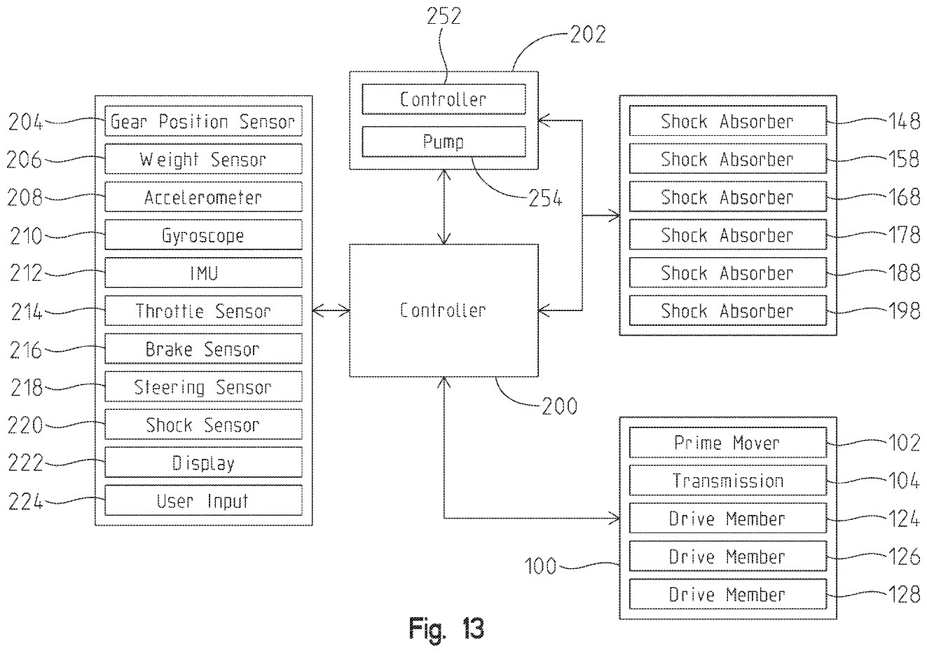

In embodiments, referring to FIGS. 9A-9B, vehicle 2 includes an electronic controller 200 (FIG. 13) operably coupled to each of first drive 124, second drive 126, third drive 128, and controller 200 is configured to operate each of first drive 124, second drive 126, and third drive 128 between the locked and unlocked condition. Electronic controller 200 is operably coupled to a gear position sensor 204 which may determine a state, or position, of transmission 104 (e.g., High, Low, Neutral, Reverse, Park or 1^{st}, 2^{nd}, 3^{rd}, 4^{th}, 5^{th}, R, P, etc.). In embodiments, electronic controller 200 is configured to alter the condition of each of first drive 124, second drive 126, and third drive 128 in response to a determination of a specific gear position. In embodiments, when transmission 104 is in a ‘Park’ state, controller 200 is configured to alter the condition, or state of each of first drive 124, second drive 126, and third drive 128 to a locked condition, which helps lock ground engaging members 4, 6, 8, 10, 12, 14 to help maintain vehicle 2 in a non-moving, or Parked condition.

Referring to FIG. 9B, a process 90 starts with a step 92 to determine if the transmission 104 is in a ‘Park’ condition. If it is determined that transmission 104 is in a ‘Park’ condition, process 90 proceeds to step 94 and alters the operating state of each of drives 124, 126, 128 to the Locked condition. If it is determined, in step 92, that transmission 104 is not in a ‘Park’ condition, process 90 repeats until step 92 is satisfied.

In embodiments, first drive 124 is supported by first casting 68, second drive 126 is supported by second casting 70, and third drive 128 is supported by third casting 72. In further embodiments, halfshafts 130, 132, 134 are coupled to drives 124, 126, 128, respectively, and extend through castings 68, 70, 72, respectively.

Referring now to FIGS. 10-12, vehicle 2 includes a front suspension 140 positioned at a generally forwardmost portion of vehicle 2. Front suspension 140 is coupled between frame 16 and each of front left ground engaging member 4 and front right ground engaging member 6. Front suspension 140 generally comprises a first suspension 142 coupled between frame 16 and front left ground engaging member 4 and a second suspension 152 coupled between frame 16 and front right ground engaging member 6. In the present embodiment, each of first suspension 142 and second suspension 152 are dual A-arm suspensions. That is, first suspension 142 includes a first control arm, or lower control arm 144, and a second control arm, or upper control arm 146. A first shock absorber 148 is coupled between upper control arm 146 and u-shaped frame member 46 of frame 16. In embodiments, first shock absorber 148 is coupled between lower control arm 144 and u-shaped frame member 46 of frame 16. Further, second suspension 152 includes a first control arm, or lower control arm 154, and a second control arm, or upper control arm 156. A second shock absorber 158 is coupled between upper control arm 156 and u-shaped frame member 46 of frame 16. In embodiments, second shock absorber 158 is coupled between lower control arm 154 and u-shaped frame member 46 of frame 16.

Still referring to FIGS. 10-12, vehicle 2 includes a rear suspension 180 positioned at a generally rearwardmost portion of vehicle 2. Rear suspension 180 is coupled between frame 16, more specifically, rear frame portion 22, and each of rear left ground engaging member 12 and rear right ground engaging member 14. Rear suspension 180 generally comprises a third suspension 182 coupled between frame 16 and rear left ground engaging member 12 and a fourth suspension 192 coupled between frame 16 and rear right ground engaging member 14. In the present embodiment, each of third suspension 182 and fourth suspension 192 are dual A-arm suspensions. That is, third suspension 182 includes a first control arm, or lower control arm 184, and a second control arm, or upper control arm 186. A third shock absorber 188 is coupled between upper control arm 186 and second cross member 76 of rear frame portion 22. In embodiments, third shock absorber 188 is coupled between lower control arm 184 and second cross member 76 of rear frame portion 22. Further, fourth suspension 192 includes a first control arm, or lower control arm 194, and a second control arm, or upper control arm 196. A fourth shock absorber 198 is coupled between upper control arm 196 and second cross member 76 of rear frame portion 22. In embodiments, fourth shock absorber 198 is coupled between lower control arm 194 and second cross member 76 of rear frame portion 22. In embodiments, a sway bar 185 is coupled between upper control arm 186 and upper control arm 196.

Still referring to FIGS. 10-12, vehicle 2 includes a middle suspension 160 positioned at a generally middle portion of vehicle 2. Middle suspension 160 is coupled between frame 16, more specifically rear frame portion 22, and each of middle left ground engaging member 8 and middle right ground engaging member 10. Middle suspension 160 generally comprises a fifth suspension 162 coupled between frame 16 and middle left ground engaging member 8 and a sixth suspension 172 coupled between frame 16 and middle right ground engaging member 10. In the present embodiment, each of fifth suspension 162 and sixth suspension 172 are dual A-arm suspensions. That is, fifth suspension 162 includes a first control arm, or lower control arm 164, and a second control arm, or upper control arm 166. A fifth shock absorber 168 is coupled between upper control arm 166 and first cross member 74 of rear frame portion 22. In embodiments, fifth shock absorber 168 is coupled between lower control arm 164 and first cross member 74 of rear frame portion 22. Further, sixth suspension 172 includes a first control arm, or lower control arm 174, and a second control arm, or upper control arm 176. A sixth shock absorber 178 is coupled between upper control arm 176 and first cross member 74 of rear frame portion 22. In embodiments, sixth shock absorber 178 is coupled between lower control arm 174 and first cross member 74 of rear frame portion 22. In embodiments, a sway bar 165 is coupled between upper control arm 166 and upper control arm 176.

In embodiments, each of shock absorbers 148, 158, 168, 178, 188, 198 are coil over shock absorbers, external bypass shock absorbers, internal bypass shock absorbers, air shocks, emulsion shock absorbers, or another type of shock absorber. In embodiments, each of shock absorbers 148, 158, 168, 178, 188, 198 are electronically adjustable shock absorbers which may be configured to adjust one or both of a compression damping characteristic and a rebound damping characteristic. Additional details regarding adjustable shock absorber can be found in U.S. patent application Ser. No. 14/507,355, filed Oct. 6, 2014, titled VEHICLE HAVING SUSPENSION WITH CONTINUOUS DAMPING CONTROL; U.S. patent application Ser. No. 15/618,793, filed Jun. 9, 2017, titled ADJUSTABLE VEHICLE SUSPENSION SYSTEM; U.S. patent application Ser. No. 15/816,368, filed Nov. 17, 2017, titled VEHICLE HAVING ADJUSTABLE SUSPENSION; U.S. patent application Ser. No. 16/198,280, filed Nov. 21, 2018, titled VEHICLE HAVING ADJUSTABLE COMPRESSION AND REBOUND DAMPING, the entire disclosures of which are expressly incorporated by reference herein.

Now referring to FIG. 13, vehicle 2 includes electronic controller 200. Electronic controller 200 is operably coupled to powertrain 100, and thereby, operably coupled to prime mover 102, transmission 104, drive member 124, drive member 126, and drive member 128. That is, electronic controller 200 is configured to control drive members 124, 126, 128 between the locked and unlocked conditions. In embodiments, electronic controller 200 is operably coupled to a ride height adjustment system 202, and each of electronic controller 200 and ride height adjustment system 202 are operably coupled to shock absorbers 148, 158, 168, 178, 188, 198.

In embodiments, controller 200 is operably coupled to a plurality of sensors supported by vehicle 2. Gear position sensor 204 is configured to determine a gear position of transmission 104 (e.g., ‘Park’ gear, ‘High’ gear, ‘Low’ gear, ‘Neutral’ gear, ‘Reverse’ gear). One or more weight sensors 206 may be configured to determine a weight on vehicle 2. In embodiments, a weight sensor 206 may be placed in one or more of seats 28 (i.e., to determine the weight of, or presence of, a passenger or operator), storage area 23, or other area of vehicle 2. An accelerometer 208 may be supported by vehicle 2 and configured to determine one or more of a lateral acceleration, longitudinal acceleration, or a vertical acceleration. A gyroscope 210 may be supported by vehicle 2 and configured to determine a rotational rate, or a rotational acceleration, such as a roll rate, a pitch rate, and a yaw rate. In embodiments, an Inertial Measurement Unit (IMU) 212 is configured to determine one or more linear acceleration values (e.g., lateral acceleration, longitudinal acceleration, vertical acceleration) and one or more rotational rate values (e.g., pitch rate, yaw rate, roll rate). A throttle sensor 214 may include one or more sensors configured to determine a throttle input position, a throttle valve angle, or another throttle characteristic. A brake sensor 216 may include one or more sensors configured to determine a brake input position, a brake sensor value or another brake characteristic. A steering sensor 218 may include one or more sensors configured to determine a steering angle value, a steering position sensor, or another steering characteristic. A shock sensor 220 may include one or more sensors configured to determine a height, relative position, damping value, or other characteristic of one or more of shock absorbers 148, 158, 168, 178, 188, or 198. Vehicle 2 may also include a display 222 supported by frame 16. Display 222 may be positioned within operator area 26 and may be visible by an operator or passenger of vehicle 2. A user input 224 may be actuatable by an operator or passenger of vehicle 2 and may be positioned on or adjacent to display 222.

Referring again to FIGS. 10-12, middle suspension 160 is generally positioned within first frame portion 52 and rear suspension 180 is generally positioned within second frame portion 54. Referring to FIG. 12, first frame portion 52 includes a first frame member 232 and a second frame member 234. First frame member 232 extends downwardly from first frame members 58 to second casting 70 and second frame member 234 extends downwardly from first frame members 58 to second casting 70 at a position rearwardly of first frame member 232. Second frame portion 54 includes a third frame member 236 and a fourth frame member 238. Third frame member 236 extends downwardly from second frame members 60 to third casting 72 and fourth frame member 238 extends downwardly from second frame members 60 to third casting 72 at a position rearwardly of third frame member 236.

In embodiments, first frame portion 52 and second frame portion 54 are substantially similar and/or share a plurality of similar components. In embodiments, middle suspension 160 and rear suspension 180 are the same. That is, in embodiments, fifth suspension 162 is the same as third suspension 182 and sixth suspension 172 is the same as fourth suspension 192. In embodiments, second casting 70 is constructed the same as third casting 72. In embodiments, second casting 70 and third casting 72 are constructed by a casting method. In embodiments, second frame member 234 is the same as fourth frame member 238. In embodiments, first frame portion 52 is separated from second frame portion 54 by coupling assemblies 62, frame members 64, such that second frame portion 54 is substantially similar to first frame portion 52 and placed rearwardly of first frame portion 52. In embodiments, vehicle 2 may be constructed as a vehicle with four wheels (i.e., ground engaging members 4, 6, 8, 10), and it may be beneficial to manufacture the vehicle with four wheels so that it is a longer vehicle and also increase the number of ground engaging members of the vehicle. Benefits include at least a longer wheelbase to increase the stability of vehicle 2, increase the load capacity of vehicle 2, and increase the storage capacity of vehicle 2. Additionally, reusing similar components for each of first frame portion 52 and second frame portion 54 reduces costs, increases manufacturing efficiencies, and reduces unique part count.

Still referring to FIG. 12, rear frame portion 22 comprises a storage component 240 extending between first frame portion 52 and second frame portion 54. In embodiments, storage component 240 is a storage plate, bowl, or other container structure. Storage component 240 is coupled to each of second casting 70 and third casting 72. That is, a forward extent of storage component 240 is coupled to second casting 70 and a rearward extent of storage component 240 is coupled to third casting 72. Additionally, storage component 240 is positioned vertically intermediate frame members 64 and upper frame portion 56. Further, storage component 240 is positioned vertically underneath storage area 23. In embodiments, storage component 240 is a structural member and provides additional rigidity to rear frame portion 22 and increases the bending strength of rear frame portion 22. Still referring to FIG. 12, exhaust assembly 242 extends rearwardly through rear frame portion 22 vertically underneath storage area 23. Further, exhaust conduit 244 is positioned vertically above second casting 70, third casting 72, and storage component 240. Further, in embodiments, silencer 246 is positioned longitudinally rearwardly of at least a portion of third casting 72 and longitudinally rearwardly of third shock absorber 188, fourth shock absorber 198. An open volume 241 is created between storage component 240 and exhaust assembly 242 to place storage items. In embodiments, storage component 240 defines a plurality of apertures 243 which may be used to strap, couple, or otherwise secure storage items to storage component 240. In embodiments, an access panel 250 is positioned on bed 23 and provides access to open volume 241. That is, in embodiments, storage component 240 and open volume 241 may be accessed from a top perspective. In embodiments, storage component 240 and open volume 241 may be accessed from a side of vehicle 2 (e.g., between middle suspension 160 and rear suspension 180).

Referring again to FIGS. 3A-3B, vehicle 2 is configured to operate with an adjustable ride height. In embodiments, a distance D1 is defined as the vertical distance between a ground surface G and the top surface of storage area 23. In embodiments, distance D1 is defined as the vertical distance between either end of shock absorbers 148, 158, 168, 178, 188, 198. In embodiments, distance D1 may be adjusted by ride height adjustment system 202. In embodiments, a first distance D4 is a vertical height of first shock absorber 148, a second distance D6 is a vertical height of second shock absorber 158, a third distance D8 is a vertical height of fifth shock absorber 168, a fourth distance D10 is a vertical height of sixth shock absorber 178, a fifth distance D12 is a vertical height of third shock absorber 188, and a sixth distance D14 is a vertical height of fourth shock absorber 198. Ride height adjustment system 202 may include a main reservoir 203 fluidly coupled to a plurality of secondary reservoirs by a plurality of conduits 205. Secondary reservoirs include a first reservoir 149 operably coupled to first shock absorber 148, a second reservoir 159 operably coupled to second shock absorber 158, a fifth reservoir 169 operably coupled to fifth shock absorber 168, a sixth reservoir 179 operably coupled to sixth shock absorber 178, a third reservoir 189 operably coupled to third shock absorber 188, and a fourth reservoir 199 operably coupled to fourth shock absorber 198. A pump 254 (FIG. 13) may be operably coupled with main reservoir 203 and may be configured to push fluid through conduits 205 to one or more of reservoirs 149, 159, 169, 179, 189, 199. In embodiments, a ride height controller 252 (FIG. 13) is operable to control ride height adjustment system 202. In embodiments, ride height controller 252 may be integral with electronic controller 200. In embodiments, controller 200 is operable to control ride height adjustment system 202.

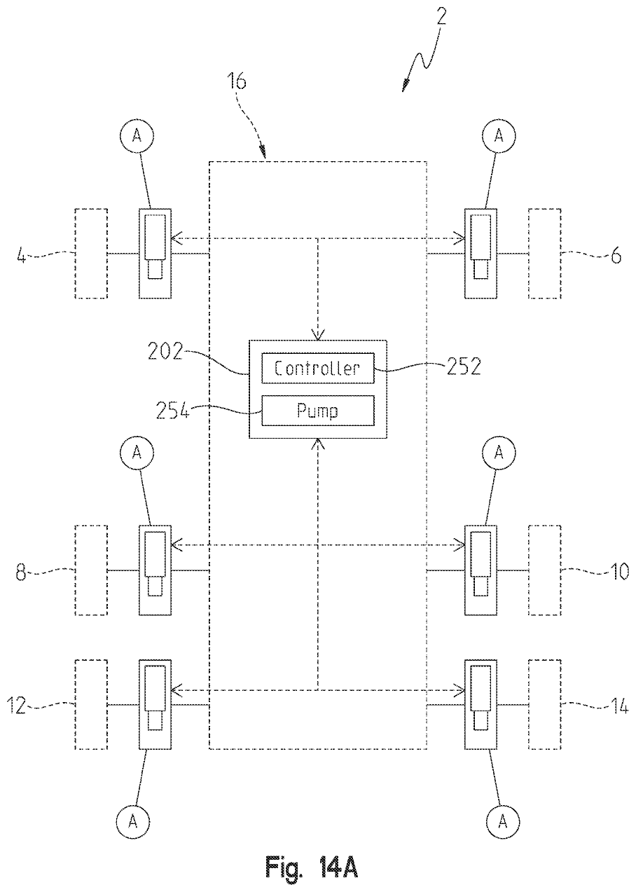

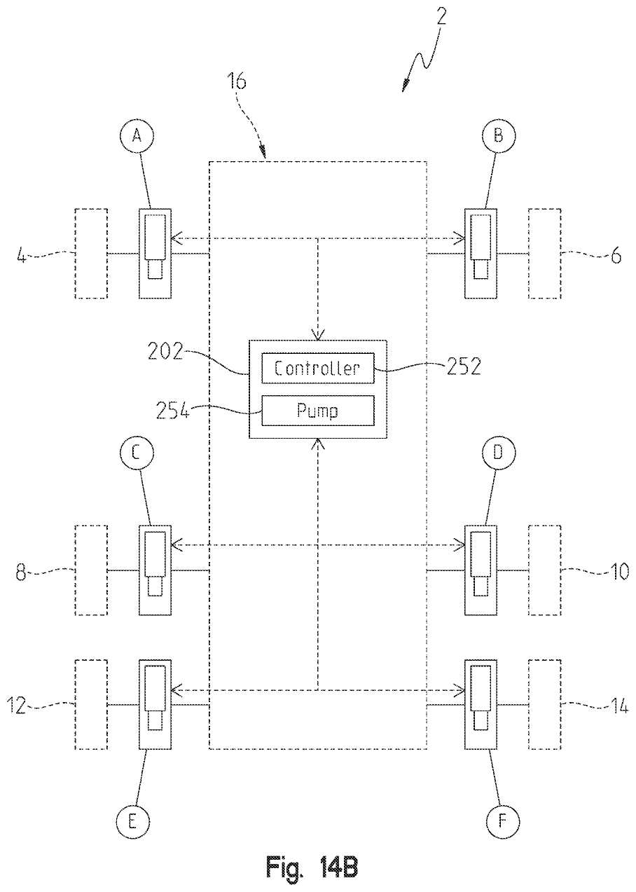

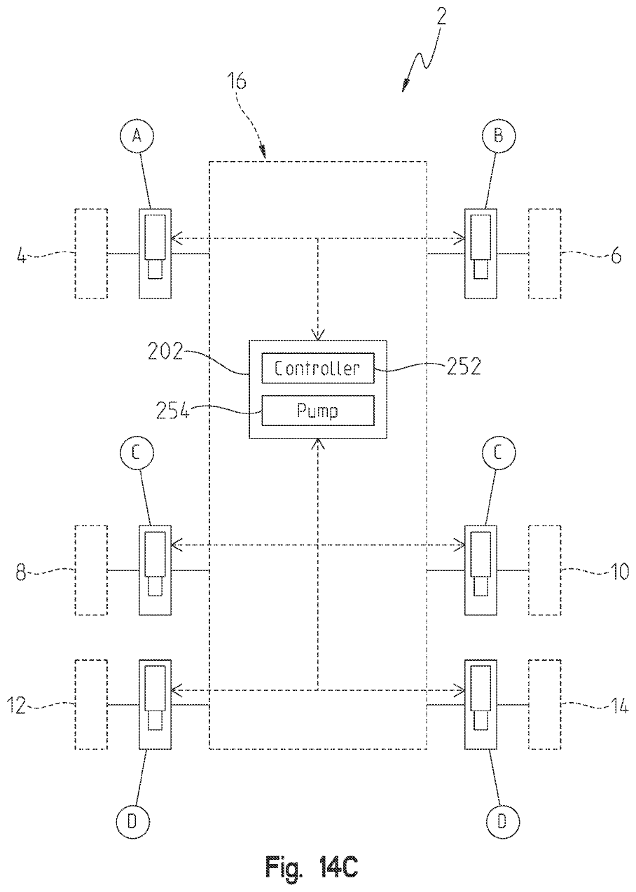

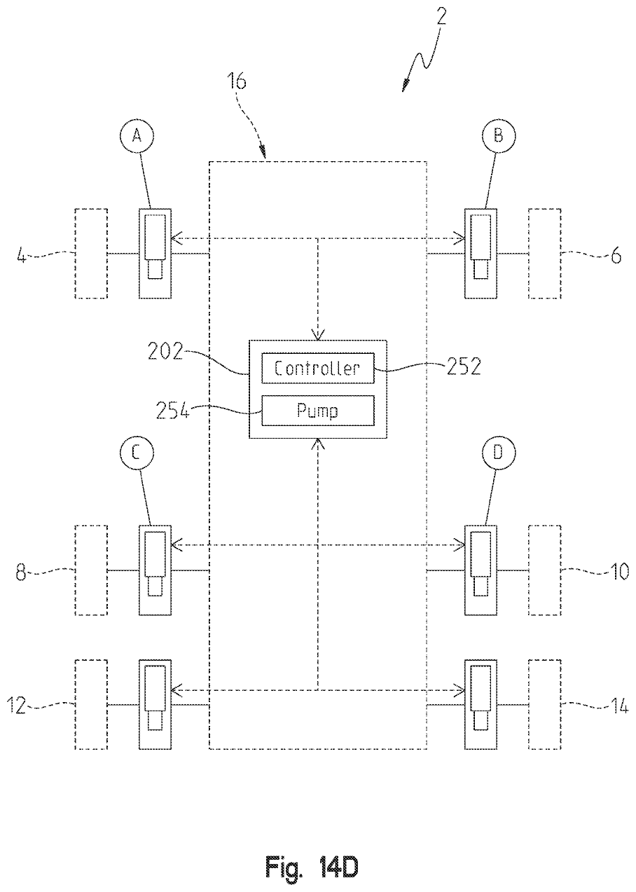

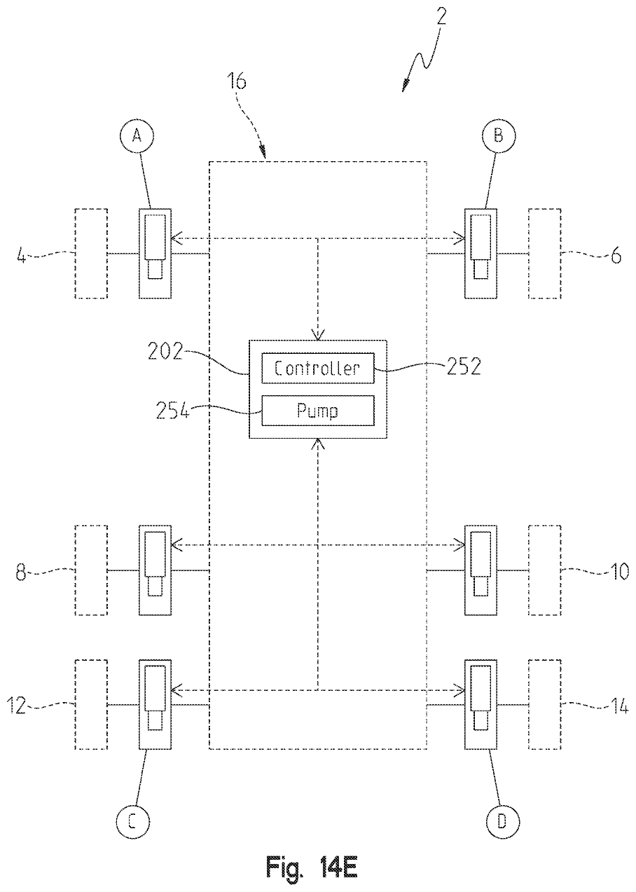

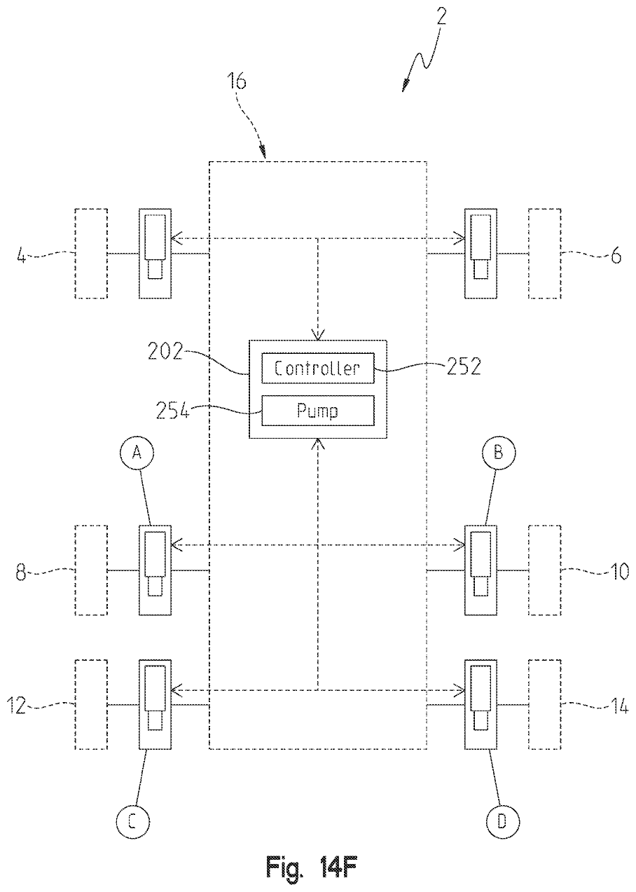

Now referring to FIGS. 14A-14F, ride height adjustment system 202 is operable to control the height of vehicle 2 in a plurality of configurations. In embodiments, ride height adjustment system 202 is a 6-channel system (i.e., may control six shock absorbers, or six groups of shock absorbers independent of one another), a 5-channel system (i.e., may control five shock absorbers, or five groups of shock absorbers independent of one another), a 4-channel system (i.e., may control four shock absorbers, or four groups of shock absorbers independent of one another), a 3-channel system (i.e., may control three shock absorbers, or three groups of shock absorbers independent of one another), a 2-channel system (i.e., may control two shock absorbers or two groups of shock absorbers independent of one another), or a single channel system (i.e., may control one shock absorber, or one group of shock absorbers).

Referring to FIG. 14A, in various embodiments, ride height adjustment system 202 is configured as a single-channel system and configured to adjust a ride height of each shock absorber 148, 158, 168, 178, 188, 198 together. That is, each shock absorber 148, 158, 168, 178, 188, 198 is in a first group A, and ride height adjustment system 202 is configured to adjust each shock absorber 148, 158, 168, 178, 188, 198 with the same or similar height adjustment. That is, ride height adjustment system 202 may increase or decrease distance D1 by altering a neutral height of each shock absorber 148, 158, 168, 178, 188, 198 (e.g., the height of each shock absorber when vehicle 2 is at rest). Increasing distance DI increases ground clearance, compensates for vehicle weight, cargo weight, or passenger weight. Decreasing distance D1 decreases ground clearance and allows for easier shipment of vehicle 2.

Referring to FIG. 14B, in various embodiments, ride height adjustment system 202 is configured as a six-channel system and configured to adjust a ride height of each shock absorber 148, 158, 168, 178, 188, 198 independent of one another. That is, first shock absorber 148 is in a first group A, second shock absorber 158 is in a second group B, fifth shock absorber 168 is in a third group C, sixth shock absorber 178 is in a fourth group D, third shock absorber 188 is in a fifth group E, fourth shock absorber 198 is in a sixth group F, and ride height adjustment system 202 may be configured to adjust each shock absorber 148, 158, 168, 178, 188, 198 with the same, or different, height adjustments. Ride height adjustment system 202 may adjust each shock absorber 148, 158, 168, 178, 188, 198 to increase or decrease distance D4, distance D6, distance D8, distance D10, distance D12, and distance D14 independent of one another.

Referring to FIG. 14C, in various embodiments, ride height adjustment system 202 is configured is configured as a four-channel system and configured to adjust a ride height of four shock absorbers, or four groups of shock absorbers, of shock absorbers 148, 158, 168, 178, 188, 198. In various embodiments, first shock absorber 148 is in a first group A, second shock absorber 158 is in a second group B, fifth shock absorber 168 and sixth shock absorber 178 are in a third group C, and third shock absorber 188 and fourth shock absorber 198 are in a fourth group D, and ride height adjustment system 202 may be configured to adjust each shock absorber associated with each of first group A, second group B, third group C, and fourth group D with the same, or different, height adjustments. Ride height adjustment system 202 may adjust shock absorber 148 of group A to increase or decrease distance D4, shock absorber 158 of group B to increase or decrease distance D6, shock absorbers 168, 178 of group C to increase or decrease distance D8, D10, shock absorbers 188, 198 of group D to increase or decrease distance D12, D14.

Referring to FIG. 14D, in various embodiments, ride height adjustment system 202 is configured is configured as a four-channel system and configured to adjust a ride height of four shock absorbers, or four groups of shock absorbers, of shock absorbers 148, 158, 168, 178. In various embodiments, first shock absorber 148 is in a first group A, second shock absorber 158 is in a second group B, fifth shock absorber 168 is in a third group C, and sixth shock absorber 178 is in a fourth group D, and ride height adjustment system 202 may be configured to adjust each shock absorber associated with each of first group A, second group B, third group C, and fourth group D with the same, or different, height adjustments. Ride height adjustment system 202 may adjust shock absorber 148 of group A to increase or decrease distance D4, shock absorber 158 of group B to increase or decrease distance D6, shock absorber 168 of group C to increase or decrease distance D8, and shock absorber 178 of group D to increase or decrease distance D10.

Referring to FIG. 14E, in various embodiments, ride height adjustment system 202 is configured is configured as a four-channel system and configured to adjust a ride height of four shock absorbers, or four groups of shock absorbers, of shock absorbers 148, 158, 188, 198. In various embodiments, first shock absorber 148 is in a first group A, second shock absorber 158 is in a second group B, third shock absorber 188 is in a third group C, and fourth shock absorber 198 is in a fourth group D, and ride height adjustment system 202 may be configured to adjust each shock absorber associated with each of first group A, second group B, third group C, and fourth group D with the same, or different, height adjustments. Ride height adjustment system 202 may adjust shock absorber 148 of group A to increase or decrease distance D4, shock absorber 158 of group B to increase or decrease distance D6, shock absorber 188 of group C to increase or decrease distance D12, and shock absorber 198 of group D to increase or decrease distance D14.

Referring to FIG. 14F, in various embodiments, ride height adjustment system 202 is configured is configured as a four-channel system and configured to adjust a ride height of four shock absorbers, or four groups of shock absorbers, of shock absorbers 168, 178, 188, 198. In various embodiments, fifth shock absorber 168 is in a first group A, sixth shock absorber 178 is in a second group B, third shock absorber 188 is in a third group C, and fourth shock absorber 198 is in a fourth group D, and ride height adjustment system 202 may be configured to adjust each shock absorber associated with each of first group A, second group B, third group C, and fourth group D with the same, or different, height adjustments. Ride height adjustment system 202 may adjust shock absorber 168 of group A to increase or decrease distance D8, shock absorber 178 of group B to increase or decrease distance D10, shock absorber 188 of group C to increase or decrease distance D12, and shock absorber 198 of group D to increase or decrease distance D14.

Referring to FIG. 14G, in various embodiments, ride height adjustment system 202 is configured is configured as a four-channel system and configured to adjust a ride height of four shock absorbers, or four groups of shock absorbers, of shock absorbers 148, 158, 168, 178, 188, 198. In various embodiments, first shock absorber 148 is in a first group A, second shock absorber 158 is in a second group B, fifth shock absorber 168 and third shock absorber 188 are in a third group C, and sixth shock absorber 178 and fourth shock absorber 198 are in a fourth group D, and ride height adjustment system 202 may be configured to adjust each shock absorber associated with each of first group A, second group B, third group C, and fourth group D with the same, or different, height adjustments. Ride height adjustment system 202 may adjust shock absorber 148 of group A to increase or decrease distance D4, shock absorber 158 of group B to increase or decrease distance D6, shock absorbers 168, 188 of group C to increase or decrease distance D8, D12, and shock absorbers 178, 198 of group D to increase or decrease distance D10, D14.

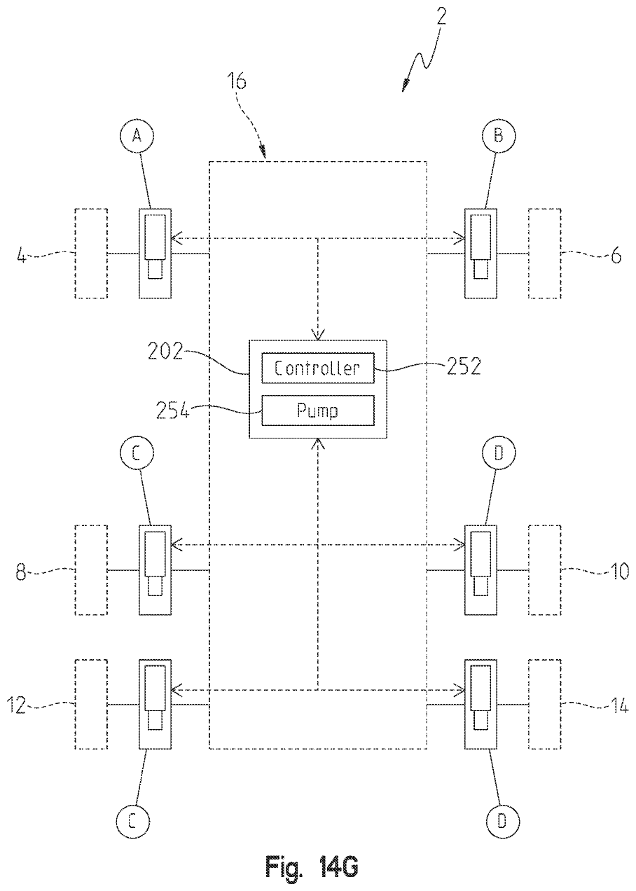

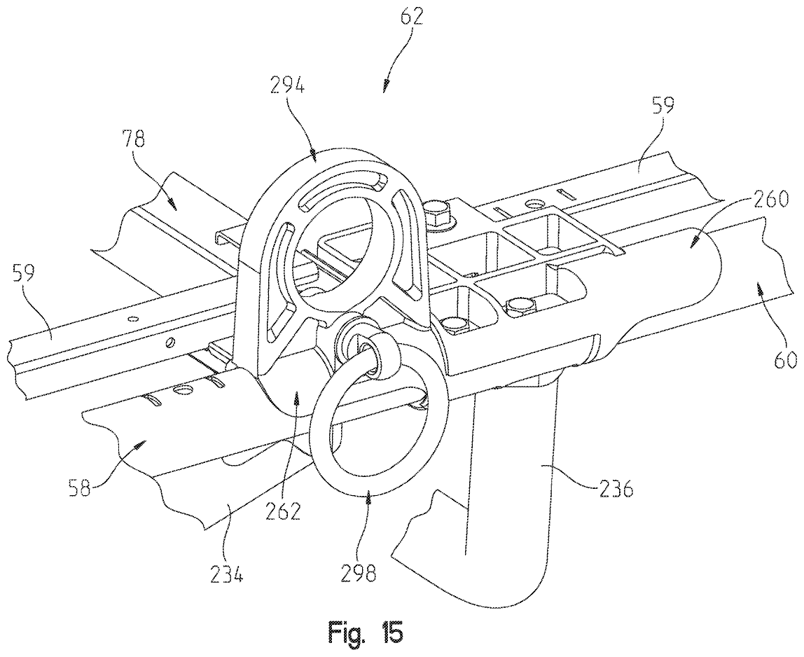

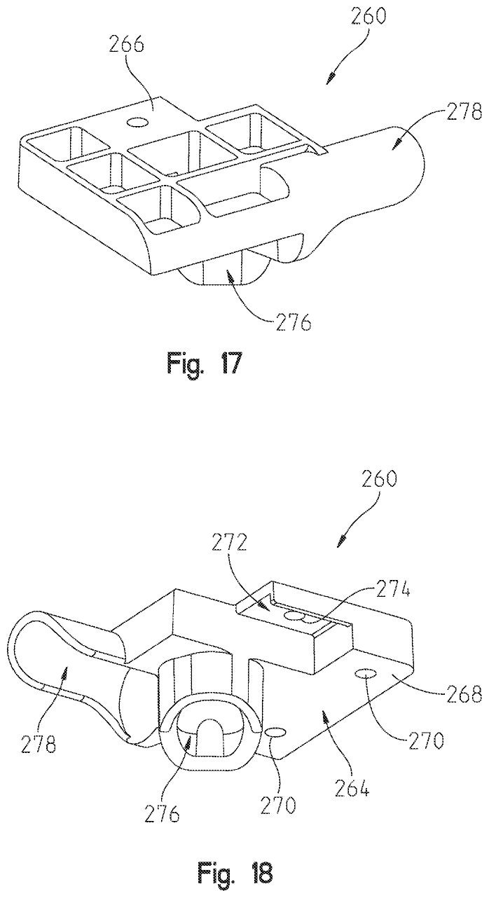

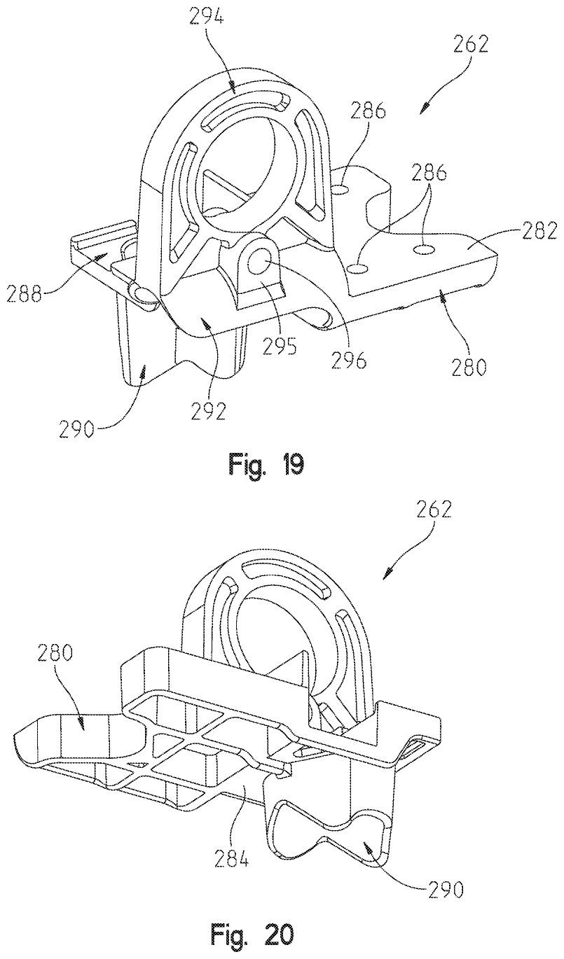

Now referring to FIGS. 15-20, a coupling assembly 62 includes a first coupling portion 260 and a second coupling portion 262. First coupling portion 260 includes a body 264 with an upper surface 266 and a lower surface 268. A plurality of apertures 270 extend between upper surface 266 and lower surface 268. Body 264 defines a first receiving portion 272 extending generally longitudinally and configured to receive frame members 59. First receiving portion 272 defines an aperture 274 extending between the first receiving portion 272 and upper surface 266. Body 264 defines a second receiving portion 276 extending generally downwardly from lower surface 268 and configured to receive third frame member 236. Body 264 also defines a third receiving portion 278 extending generally longitudinally and outwardly from body 264 and configured to receive upper frame portion 56.

Second coupling portion 262 includes a body 280 with an upper surface 282 and a lower surface 284, and a plurality of apertures 286 extend between upper surface 282 and lower surface 284. Body 280 defines a first receiving portion 288 extending generally longitudinally and may define an aperture (not shown). First receiving portion 288 is configured to receive frame members 59. Body 280 also defines a second receiving portion 290 extending generally downwardly from lower surface 284 and configured to receive second frame member 234. Body 280 also defines a third receiving portion 292 extending generally longitudinally and configured to receive first frame members 58. Second coupling portion 262 also comprises an eyelet, or hooking portion 294 coupled with body 280. In embodiments, eyelet 294 is integral with body 280. Eyelet 294 is a rounded portion configured to receive a hook, a bolt, a clevis, or another clasping member. A frame portion 295 extends between third receiving portion 292 and hooking portion 294 and frame portion 295 defines an aperture 296. The aperture 296 is configured to receive a ring assembly 298 configured to move relative to body 280.

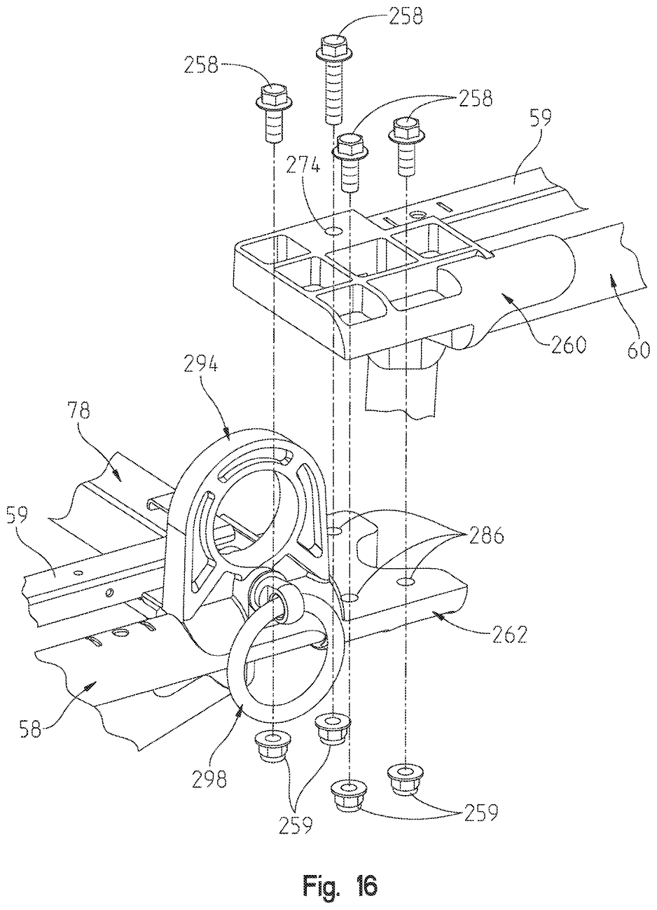

Referring to FIGS. 15-16, first coupling portion 260 is coupled with second coupling portion 262 by a plurality of fasteners 258 extending through apertures 286 of second coupling portion 262 and apertures 270 of first coupling portion 260 and a fastener 258 extending through an aperture 286 of second coupling portion 262 and aperture 274 of first coupling portion 260. Coupling assembly 62 is configured to couple together a plurality of frame members. In embodiments, coupling assembly 62 is configured to couple together six frame members. That is, coupling assembly 62 is coupled to a first frame member 59 extending longitudinally forwardly from coupling assembly 62 at first receiving portion 288, a second frame member 59 extending longitudinally rearwardly from coupling assembly 62 at first receiving portion 272, first frame members 58 extending longitudinally forwardly from coupling assembly 62 at third receiving portion 292, second frame members 60 extending longitudinally rearwardly from coupling assembly 62, second frame member 234 extending generally downwardly and forwardly from second receiving portion 290, and third frame member 236 extending generally downwardly and rearwardly from second receiving portion 276. Further, coupling assemblies 62 is constructed with hooking portion 294 positioned on one of the pair of first coupling portion 260 and second coupling portion 262. In embodiments, hooking portion 294 is positioned on first coupling portion 260, and in embodiments, hooking portion 294 is positioned on second coupling portion 262.

Referring again to FIG. 3A, hooking portions 63, 294 are spaced along frame 16. In embodiments, hooking portions 63, 294 are configured to receive hooks or latching members to allow vehicle 2 to be lifted, pulled, translated, rotated or otherwise moved. Hooking portions 63, 294 are positioned to assist in balancing vehicle 2 when lifted vertically upwardly by, for example, a crane or other lifting mechanism. Vehicle 2 has a length 300, and hooking portions 63 are positioned forwardly of operator area 26 and rearwardly from a front extent of vehicle 2 by a distance 302. Further, hooking portion 294 is positioned longitudinally rearwardly of operator area 26 by a distance 310 and is also positioned longitudinally forwardly of a rearward extent of vehicle 2 by a distance 304. In the present embodiment, hooking portion 294 is positioned longitudinally rearwardly of hooking members 63 by a distance 306.

In various embodiments, distance 302 is less than 25% of length 300, and in embodiments, distance 302 is less than 20% of length 300. In embodiments, distance 302 is approximately 18% of length 300. In embodiments, distance 302 is greater than 15% of length 300. In various embodiments, distance 304 is greater than 15% of length 300, and in embodiments, distance 304 is greater than 20% of length 300. In embodiments, distance 304 is less than 30% of length 300. In embodiments, distance 304 is approximately 22% of length 300. In various embodiments, bed length 308 is greater than 30% of length 300, and in embodiments, bed length 308 is greater than 40% of length 300. In embodiments, bed length 308 is approximately 42% of length 300. In embodiments, bed length 308 is less than 50% of length 300. In various embodiments, distance 306 is greater than 35% of length 300, and in embodiments, distance 306 is greater than 40% of length 300. In embodiments, distance 306 is greater than 50% of length 300, and in embodiments, distance 306 is approximately 60% of length 300.

In embodiments, the position of hooking portion 294 and hooking members 63 are positioned above a Center of Gravity (CG) of vehicle 2 and hooking portions 294 are longitudinally rearwardly of the CG and hooking members 63 are longitudinally forwardly of the CG. In embodiments, a lifting device (e.g., a crane, helicopter, or other lifting device with chains or straps coupled to each of hooking portions 294 and hooking members 63) may lift by each of hooking portions 294 and hooking members 63 so that the straps or chains do not contact any other part of frame assembly 16. In embodiments, hooking portions 294 and hooking members 63 are positioned to minimize differences in the load magnitude between any straps/chains.

Still referring to FIG. 3A, hooking portion 294 is positioned longitudinally rearwardly of at least a portion of ground engaging members 8, 10 and longitudinally forwardly of at least a portion of ground engaging members 12, 14. Hooking portion 294 extends upwardly above the surface of storage area 23 to receive a latching mechanism more easily for lifting.

Further, hooking portion 294 extends upwardly above each of upper frame portion 56, frame members 59, first cross member 74, second cross member 76, second cross member 76, fourth cross member 80.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1-31. (canceled)

32. A vehicle, comprising:
a plurality of ground engaging members;
a frame supported by the plurality of ground engaging members, the frame comprising:
a front frame portion surrounding an operator area; and
a rear frame portion positioned rearwardly of the front frame portion, the rear frame portion comprising a first portion and a second portion;
a first suspension coupled between the front frame portion and a first portion of ground engaging members of the plurality of ground engaging members;
a second suspension coupled between the first portion of the rear frame portion and a second portion of ground engaging members of the plurality of ground engaging members;
a third suspension coupled between the second portion of the rear frame portion and a third portion of ground engaging members of the plurality of ground engaging members;
a coupling assembly coupled between the first portion of the rear frame portion and the second portion of the rear frame portion, the coupling assembly comprising:
a first coupler member coupled to the first portion of the rear frame portion;
a second coupler member coupled to the second portion of the rear frame portion, the second coupler member configured to couple with the first coupler member; and
an eyelet member coupled to at least one of the first coupler member and the second coupler member; and
a frame portion extending between the eyelet member and the second coupler member, the frame portion defining an aperture configured to receive a ring assembly, the ring assembly being configured to move relative to the second coupler member.

33. The vehicle of claim 32, wherein the coupling assembly is positioned longitudinally intermediate the second suspension and the third suspension.

34. The vehicle of claim 32, wherein the eyelet member is positioned intermediate the second suspension and the third suspension.

35. The vehicle of claim 32, wherein the eyelet member extends upwardly above the coupling assembly.

36. The vehicle of claim 32, further comprising a forward eyelet coupled to the front frame portion.

37. The vehicle of claim 36, wherein the vehicle has a vehicle length and the forward eyelet is longitudinally spaced from a rearward eyelet by greater than 6 is missing parent: 40% of the vehicle length.

38. The vehicle of claim 32, wherein the first coupler member defines a first receiving portion configured to receive a first frame member, a second receiving portion configured to receive a second frame member, and a third receiving portion configured to receive a third frame member.

39. The vehicle of claim 32, wherein the coupling assembly is configured to couple together six frame members.

40. The vehicle of claim 32, wherein the eyelet member is integral with the second coupler member.

41. The vehicle of claim 32, wherein the rear frame portion comprises an upper frame portion and a lower frame portion vertically spaced from the upper frame portion, and the second suspension and the third suspension are each coupled between the lower frame portion and the upper frame portion.

42. The vehicle of claim 41, further comprising a storage member supported by the rear frame portion, the storage member positioned at a height vertically intermediate the lower frame portion and the upper frame portion and longitudinally intermediate the second suspension and the third suspension.

43. The vehicle of claim 42, wherein the storage member is coupled to a first casting supporting the second suspension and a second casting supporting the third suspension.

44. The vehicle of claim 32, wherein the plurality of ground engaging members includes six ground engaging members, and the first portion of ground engaging members includes two front ground engaging members, the second portion of ground engaging members includes two middle ground engaging members, and the third portion of ground engaging members includes two rear ground engaging members.

45. The vehicle of claim 32, wherein the eyelet member is positioned at a lateral extent of the rear frame portion.

46. The vehicle of claim 32, wherein the rear frame portion comprises an upper frame portion including a plurality of cross members, and the eyelet member extends upwardly above the upper frame portion.

47. A vehicle, comprising:
a plurality of ground engaging members;
a frame supported by the plurality of ground engaging members, the frame comprising a front frame portion surrounding an operator area, the frame further comprising a rear frame portion;
a first suspension coupled between the front frame portion and a first portion of ground engaging members of the plurality of ground engaging members;
a second suspension coupled between the first portion of the rear frame portion and a second portion of ground engaging members of the plurality of ground engaging members;
a third suspension coupled between the second portion of the rear frame portion and a third portion of ground engaging members of the plurality of ground engaging members;
a first eyelet coupled to the front frame portion, the first eyelet positioned forward of the operator area; and
a second eyelet coupled to the rear frame portion, the second eyelet positioned longitudinally intermediate the second suspension and the third suspension,
the rear frame portion defining an aperture configured to receive a ring assembly, the ring assembly being configured to move relative to the rear frame portion.

48. The vehicle of claim 47, wherein the vehicle has a vehicle length, and the first eyelet is longitudinally spaced from the second eyelet by greater than 17 is missing parent: 40% of the vehicle length.

49. The vehicle of claim 47, wherein the vehicle has a vehicle length, and the second eyelet is positioned forwardly of a rear extent of the vehicle by a distance greater than 18 is missing parent: 20% of the vehicle length.

50. The vehicle of claim 47, wherein the second eyelet is positioned at a lateral extent of the rear frame portion.

51. A vehicle, comprising:
a plurality of ground engaging members;
a frame supported by the plurality of ground engaging members, the frame comprising:
a front frame portion surrounding an operator area; and
a rear frame portion positioned rearwardly of the operator area, the rear frame portion comprising a lower frame portion and an upper frame portion vertically spaced from the lower frame portion;
a first suspension coupled between the front frame portion and a first portion of ground engaging members of the plurality of ground engaging members;
a second suspension coupled between the rear frame portion and a second portion of ground engaging members of the plurality of ground engaging members, the second suspension coupled between the lower frame portion of the rear frame portion and the upper frame portion of the rear frame portion;
a third suspension coupled between the rear frame portion and a third portion of ground engaging members of the plurality of ground engaging members, the third suspension longitudinally spaced from the second suspension and coupled between the lower frame portion of the rear frame portion and the upper frame portion of the rear frame portion; and
a storage member supported by the rear frame portion, the storage member positioned at a height vertically intermediate the lower frame portion and the upper frame portion and longitudinally intermediate the second suspension and the third suspension,
the rear frame portion defining an aperture configured to receive a ring assembly, the ring assembly being configured to move relative to the rear frame portion.
